(19) United States
(12) Patent Application Publication
(10) Pub. No.: US 2015/0296401 A1
(43) Pub. Date: Oct. 15, 2015

(54) METHOD AND APPARATUS FOR BLOCKING SPURIOUS INTER-FREQUENCY AND INTER-SYSTEM MEASUREMENT REPORTS

(71) Applicant: RENESAS MOBILE CORPORATION, Tokyo (JP)

(72) Inventors: Christian Hamilton, Basingstoke (GB); Kelvin Ayres, Reading (GB)

(73) Assignee: RENESAS MOBILE CORPORATION, Tokyo (JP)

(21) Appl. No.: 14/439,591

(22) PCT Filed: Oct. 24, 2013
(86) PCT No.: PCT/IB2013/059623

§ 371 Date: Apr. 29, 2015

(30) Foreign Application Priority Data
Oct. 30, 2012 (GB) 1219516.0

(51) Int. Cl. H04W 24/10; H04L 12/26; H04W 24/02

(52) U.S. Cl. CPC H04W 24/10; H04W 24/02; H04L 43/16; H04L 43/02

(57) ABSTRACT

In accordance with an example embodiment of the present invention, a method is disclosed that comprises obtaining a new signal quality threshold based on a base signal quality threshold and a context-sensitive buffer margin and setting a current triggering threshold to the obtained new signal quality threshold if the current triggering threshold is smaller than the obtained new signal quality threshold. The method also comprises, if a measured signal quality on a currently active cell falls below the current trigging threshold: obtaining a combined quality of all cells within an active cell set and an inter-frequency signal quality or an inter-radio access technology (RAT) signal quality from an inter-frequency or inter-RAT cell set that is within a receiving range of the wireless device; and blocking a measurement report to a wireless network element if the obtained combined signal quality is equal to or better than the obtained inter-frequency or inter-RAT signal quality, wherein the measurement report is either an inter-frequency measurement report or an inter-radio access technology (RAT) measurement report.

### CROSS REFERENCE TO RELATED APPLICATION

This application claims the benefit under 35 U.S.C. §119(a) and 37 CFR §1.55 to UK patent application no. GB 1219516.0, filed on Oct. 30, 2012, the entire content of which is incorporated herein by reference.

### TECHNICAL FIELD

An example embodiment of the present invention relates generally to wireless communications, and, more particularly, to blocking spurious inter-frequency and inter-radio access technology measurements when intra-frequency quality is above a quality threshold.

### BACKGROUND

It is becoming increasingly common for a user equipment (UE) such as a mobile handset to support multiple radio access technologies (RATs) so that the UE can roam freely from one type of wireless network to another. Commonly supported RATs include GSM, WCDMA, and more recently LTE. A UE may measure and report to a connected base station, also known as an active cell such as eNodeB of LTE, a link quality on continuous basis as prescribed by an appropriate standards protocol. The connected base station may set a quality threshold and once a measured link quality falls below the threshold, the base station may request that the UE performs measurements on other frequencies or RATS to aid in decisions to switch the UE to a different channel of a same or different RAT to maintain certain level of service quality.

If a voice or a data call is in progress when the UE switches to a different frequency of a same or different RAT, the user experience may be negatively affected if the call drops or the service is delayed beyond normal expectation in a handover process. Call drop or service delay may be more likely to occur when the user of a mobile handset is moving at high speed such as travelling in a fast-moving car or on a train. In this high mobility scenario, it may be difficult to maintain the connection to a wireless network such as a UTRAN network. At least part of the reason is that the controlling wireless network element applies a one-size-fit-all measurement configuration to the UE to cover all use cases, which may not be suitable for the high mobility use case. The UE sends either periodic or event driven measurement reports to an active cell based on the measurement configuration specified by the network. Based on these measurement reports the active cell may initiate a handover process. The one-size-fits-all configuration may work well for majority of use cases but not for some other cases such as high mobility situations. One challenge is to have a measurement configuration that takes a particular context such as highly mobile situation into consideration to filter out spurious inter-RAT or inter-frequency reports.

Following abbreviations are used in this application.
EUTRAN—Enhanced UTRAN
CPICH EcNo—Common Pilot Channel-Energy Per Chip to noise ratio in dB.
LTE—Long Term Evolution
RAN—Radio Access Network
RRC—Radio Resource Control
RSRQ—Reference Signal Received Quality
RSRP—Reference Signal Received Power
RSSI—received Signal Strength Indication
SIB3—System Information Block type 3
UE—User Equipment
UMTS—Universal Mobile Telecommunications System
UTRAN—UMTS Radio Access Network

### SUMMARY

Various aspects of the invention are set out in the claims.

In accordance with an example embodiment of the present invention, a method for a wireless device to control spurious measurement reporting is provided, the method comprising: obtaining a new signal quality threshold based on a base signal quality threshold and a context-sensitive buffer margin; and setting a current triggering threshold to the obtained new signal quality threshold if the current triggering threshold is smaller than the obtained new signal quality threshold. The method also comprises, if a measured signal quality on a currently active cell falls below the current trigging threshold: obtaining a combined signal quality of all cells within an active cell set and an inter-frequency signal quality or an inter-radio access technology (RAT) signal quality from an inter-frequency or inter-RAT cell set that is within a receiving range of the wireless device; and blocking a measurement report to a wireless network element if the obtained combined signal quality is equal to or better than the obtained inter-frequency signal quality or inter-RAT signal quality, the measurement report being one of an inter-frequency measurement report or an inter-RAT measurement report.

In accordance with an example embodiment of the present invention, an apparatus to control spurious measurement reporting is provided, the apparatus comprises a processing system, which may be embodied by at least one processor, and at least one memory including computer program code. The processing system is arranged to cause the apparatus to obtain a new signal quality threshold based on a base signal quality threshold and a context-sensitive buffer margin; and set a current triggering threshold to the new signal quality threshold if the current triggering threshold is smaller than the new signal quality threshold. The processing system is also arranged if a measured signal quality on a currently active cell falls below the current trigging threshold: to obtain a combined signal quality of all cells within an active cell set and an inter-frequency signal quality or RAT signal quality from an inter-frequency or inter-RAT cell set that is within a receiving range of the wireless device; and to block a measurement report to a wireless network element if the obtained combined signal quality is equal to or better than the obtained inter-frequency signal quality or inter-RAT signal quality, the measurement report being one of an inter-frequency measurement report or an inter-RAT measurement report.

In accordance with another example embodiment of the present invention, a computer program product is provided. The computer program product comprises a computer-readable medium comprising a set of instructions, which, when executed by a wireless device, causes the wireless device to: obtain a new signal quality threshold based on a base signal quality threshold and a context-sensitive buffer margin; and set a current triggering threshold to the new signal quality threshold if the current triggering threshold is smaller than the new signal quality threshold. The set of instructions, when executed by the wireless device, and if a measured signal quality on a currently active cell falls below the current trigging threshold, causes the wireless device to: obtain a combined signal quality of all cells within an active cell set and an inter-frequency signal quality or an inter-radio access technology (RAT) signal quality from an inter-frequency or inter-RAT cell set that is within a receiving range of the wireless apparatus; and block a measurement report to a wireless network element if the obtained combined signal quality is equal to or better than the obtained inter-frequency or inter-RAT signal quality, the measurement report being an inter-frequency measurement report or an inter-RAT measurement report.

In accordance with another example embodiment of the present invention, an apparatus for use in a wireless device comprises means configured to obtain a new signal quality threshold based on a base signal quality threshold and a context-sensitive buffer margin; means configured to set a current triggering threshold to the new signal quality threshold if the current triggering threshold is smaller than the new signal quality threshold; and means configured to, if a measured signal quality on a currently active cell falls below the current trigging threshold, obtain a combined signal quality of all cells within an active cell set and an inter-frequency signal quality or an inter-radio access technology (RAT) signal quality from an inter-frequency or inter-RAT cell set that is within a receiving range of the wireless device; and to block the measurement report to a wireless network element if the obtained combined signal quality is equal to or better than the obtained inter-frequency or inter-RAT signal quality.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention;

FIG. 2 illustrates an example method for blocking spurious inter-frequency/inter-RAT measurement reports when intra-frequency signal quality is above a quality threshold in accordance with an example embodiment of the invention;

FIG. 3a illustrates an example method for filtering out spurious intra-frequency measurements in accordance with an example embodiment of the invention;

FIG. 3b illustrates an example method for filtering out inter-frequency/inter-RAT spurious measurements in accordance with an example embodiment of the invention; and

FIG. 4 illustrates an example wireless apparatus in accordance with an example embodiment of the invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. The terms “active cell,” and “active base station” may be used interchangeably to refer to a wireless network element that is directed connected to a UE via a wireless connection and functions as a controlling network element. Similarly, the terms “UE” and “mobile handset” and the terms “inter-system” and “inter-RAT” may be used interchangeably. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

A method, apparatus and computer program product are provided in accordance with an example embodiment of the present invention in order to manage measurement configurations in such a way that spurious measurements can be filtered out to avoid unnecessary handovers and to improve the user experience. The term “standards protocol” is generally understood to relate to one or more protocols that allow transmission of data packets between a UE and a connected wireless network element such as a base station or an active cell. Some examples of measurement configurations are provided in a Third Generation Partnership Project (3GPP) Technical Standard 25.331 Release 9 section 14.2.1.4.

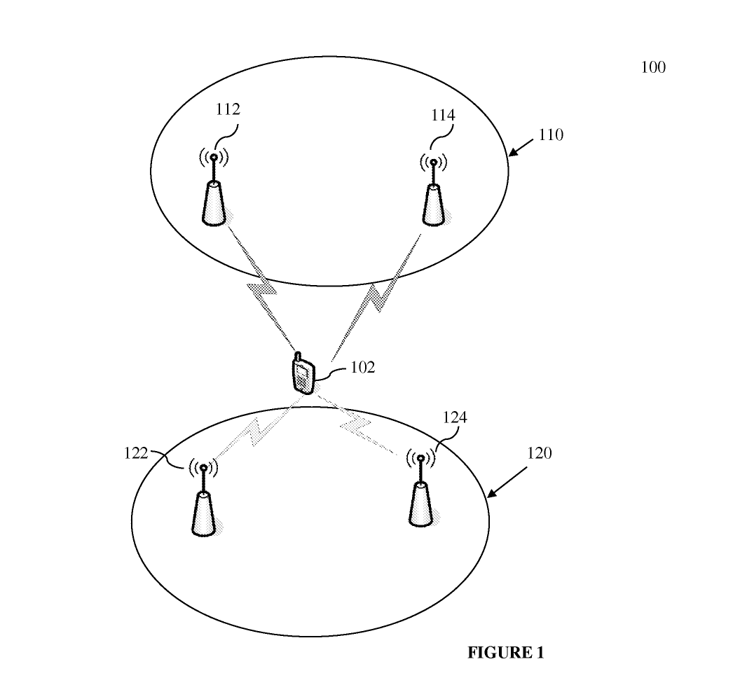

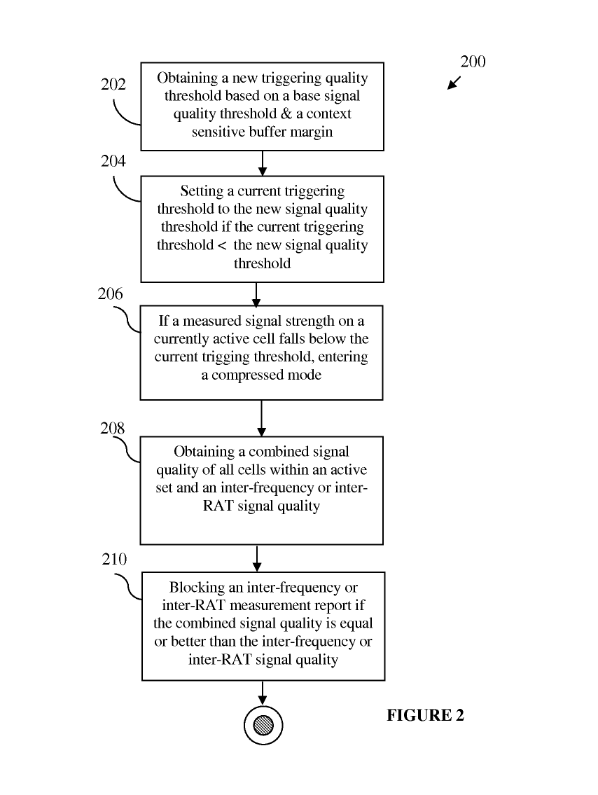

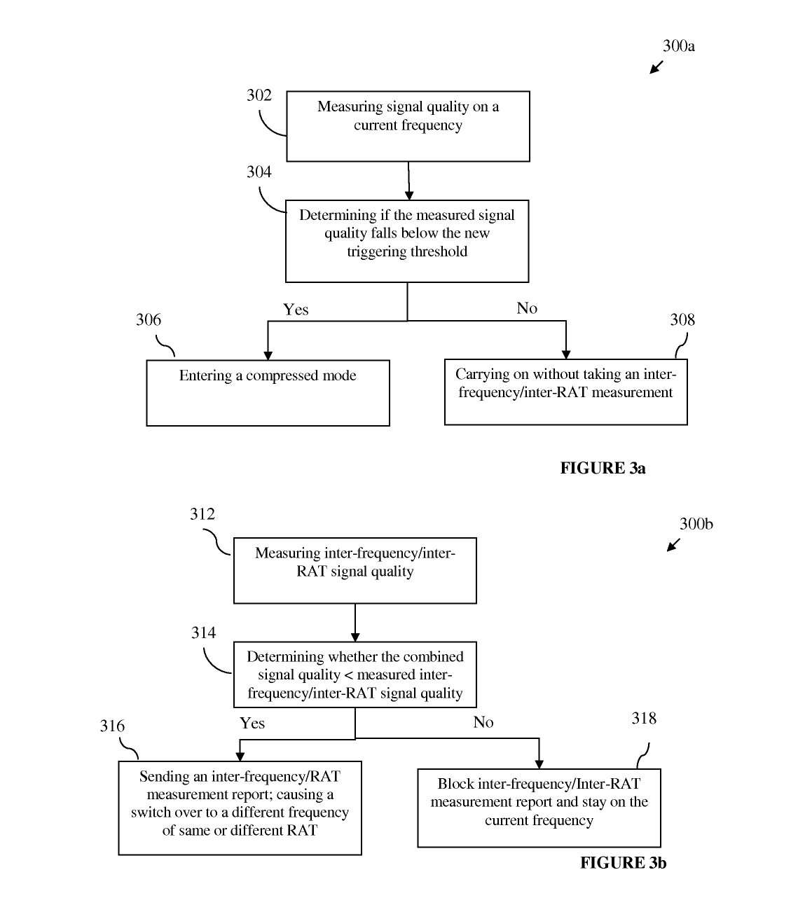

The system of an embodiment of the present invention may include an example wireless network 100 which includes an active cell set 110, an inter-frequency/inter-RAT cell set 120 and a UE 102 collectively carrying out the operations of the present invention. The apparatus 400 as generally described below in conjunction with FIG. 1 for performing one or more of the operations set forth FIGS. 2-3, is also described below.

Referring now to FIG. 1, an example wireless network 100 is provided in accordance with an example embodiment of the invention. The wireless system 100 includes an active cell set 110 which in turn includes two base stations 112 and 114; and the base stations 112 and 114 can be a UTRAN base stations nodeB or long-term evolution (LTE) base stations eNodeB and they may operate on the same frequency. The example wireless system 100 also includes a UE 102 and an inter-frequency/inter-RAT cell set 120. In one example embodiment, the UE 102 is connected to the base station 112 (also known as active cell) in the active cell set 110 and can also receive signals from the other base station 114 of the active cell set. The inter-frequency/inter-RAT base stations 122 and 124 are also within the receiving range of the UE 102 and may operate on a different frequency of a same or different RAT.

In one example embodiment, the UE 102 is engaged in a voice or data call while moving at a high speed through an area covered by the active cell set 110 and the inter-frequency/RAT cell set 120. The signal quality of UE 102 may deteriorate to a point that falls below a preset triggering threshold partially due to the fact it is fast moving away from the connected active cell 112. Instead of measuring and reporting the qualities of inter-frequency/RAT signals of the cells 122 and 124 to its active cell 112, which may cause the UE 102 to switch to one of the cells and may potentially result in a call drop or a call delay, the UE 102 applies a buffer margin to a preset triggering threshold and obtains a new triggering threshold based on the buffer margin and a current triggering threshold. The buffer margin factors in the highly mobile environment and adjusts the current triggering threshold accordingly. If the current signal quality is within the new triggering threshold, the UE 102 chooses to stay on the current frequency channel. If the current signal quality falls below the new triggering thresholds, instead of measuring and directly reporting an inter-frequency/inter-RAT measurement to the active cell 112, the UE 102 calculates a combined signal quality of the active cell set 110 and obtains a signal quality from the inter-frequency/inter-RAT cell set 120. If the combined signal quality is at least equal to the inter-frequency/inter-RAT signal quality of the cell set 120, the UE 102 may block all inter-frequency/inter-RAT measurement reports and thus prevent a potential switchover to a different frequency of the same or different RAT and reduce a chance for a call drop or call delay. On the other hand, if the combined signal quality is less than the inter-frequency/inter-RAT signal quality, the UE 102 may directly report the measurement to the active cell 112 and cause a switchover to an inter-frequency/inter-RAT cell 122 or 124.

FIG. 2 illustrates an example method 200 for blocking spurious inter-frequency/inter-RAT measurement reports when intra-frequency signal quality is above a quality threshold in accordance with an example embodiment of the invention. The method 200 includes obtaining a new triggering quality threshold at block 202, setting a current triggering threshold to the new signal quality threshold at block 204, entering a compressed mode of operation if a measured signal quality on a currently active cell falls below the current trigging threshold at block 206. The method 200 also includes obtaining a combined signal quality of all cells within an active set at block 208, and blocking an inter-frequency/inter-RAT measurement report if the combined signal quality is equal to or better than the inter-frequency/inter-RAT signal quality at block 210.

In one example embodiment, obtaining a new triggering quality threshold at block 202 may include determining a context-sensitive buffer margin, and applying the context sensitive buffer margin to a current triggering threshold. Determining the context-sensitive buffer margin may involve conducting empirical studies based on a large amount of historical data for a specific context. Various contexts may contribute to different levels of tolerance to signal deteriorations and one-size-fit-all quality threshold may cause unnecessary switchover to different frequency of a same or different RAT and may cause unnecessary call drops or delays. Other example contexts may include stationary environment where UEs are largely stationary with little mobility and semi mobile environment where UEs may move around but at a relatively low speed and within a relative small area. In one embodiment, a large amount of data is collected for each context and a context-specific or context-sensitive buffer margin is obtained from empirical studies. The buffer margin is preferably such that it provides an adjustment to the preset quality threshold and results in a minimum number of possible switchover and call drops. Also the context-sensitive buffer margin may be set in such a way that it allows enough time for the UE 102 to complete a handover before the inter-frequency or inter-RAT signal strength deteriorates below a base signal quality threshold that is set and sent by the active cell 112 in a standard protocol message such as a System Information Block (SIB) 3 message.

In an example embodiment, a context may be further divided into sub-contexts to further account for significant differences within a specific context. For example, a highly mobile context may be further divided into different sub-contexts according to different speed ranges within the highly mobile context, to accommodate variations in tolerance to signal deteriorations caused by different speeds of the UE 102 in a highly mobile environment. The buffer margin may be a positive or a negative number, depending on a specific context and the value of a preset threshold. Generally, a positive buffer margin increases a quality threshold and a negative buffer margin decreases a quality threshold. The context-sensitive buffer margins in general may be obtained in an offline manner based on a large amount of historical data and may be downloaded into a memory of the UE 102 via a software download or an initial installation. When a context or a sub-context is identified, the UE 102 may dynamically apply the buffer margin to the current triggering threshold to obtain a new triggering signal quality threshold.

In one example embodiment, setting a current triggering threshold to the new signal quality threshold at block 204 may include comparing the current triggering threshold against the new signal quality threshold and setting the current triggering threshold to the new signal quality threshold if the current triggering threshold is less than the new signal quality threshold. The operation of comparing the current triggering threshold with the new signal quality threshold may be triggered when the UE 102 enters a new context or at a scheduled time for signal quality measurement through a standard protocol operation such as LTE radio resource control (RRC). The current triggering threshold may be initially set to a base signal quality threshold sent by the active cell or active base station 112 via a broadcast message at a fixed time interval or triggered by an event, as prescribed by a standard protocol such as LTE RRC. The current triggering threshold may have been set to a value different from the base signal quality threshold because a buffer margin of a different context may have been applied to the previous triggering threshold already. The operation of setting a current triggering threshold to the new signal quality threshold at block 204 may also be triggered when the service quality level deteriorates to a certain threshold point, such as a threshold of call drops. Thus, as described above, the potential interference to the normal protocol operation may be minimized.

In one example embodiment, entering a compressed mode of operation at block 206 may include measuring a current signal quality, comparing it against the current triggering threshold and entering a compressed mode as directed by a controlling network entity such as a nodeB of a LTE network, if the measured signal quality falls below the current triggering threshold. For example, the operation of entering compressed mode at block 206 may take place only if the newly measured signal quality falls below the newly set current triggering threshold. This has an effect of avoiding having the compressed mode active too often and minimizing the impacts on the overall system capacity because the compressed mode operation would otherwise tax the system-wide resources at both the UE 102 and the active cell 112. For example, in an UTRAN system, if a UE triggers the event 2D at a lower threshold in a high mobility case, it may likely have the effect of causing compressed mode to be activated more often and thereby increase signaling overhead (to activate/deactivate the compressed mode). This may lead to reduced network capacity due to the fact that more UEs have compressed mode enabled more often, because during a compressed mode the UE transmits at a higher power, which in turn causes interference and thereby reduces system capacity.

In one example embodiment, obtaining a combined signal quality of all cells within the active cell set at block 208 may include measuring a signal quality of each cell in the active cell set, and applying a weighted arithmetic function to arrive at a combined signal quality. In one embodiment, the UE 102 may measure a signal quality of all cells in the active cell set 110 one by one and in this case the current active cells 112 and cell 114. Then the UE 102 applies the following function to obtain a combined or average signal quality: 10*LOG 10(Cell₁EcNo+Cell₂EcNo . . . +CellxEcNo), where Cell₁EcNo is a signal quality of cell₁, Cell₂EcNo is a signal quality of cell₂ and CellxEcNo is a signal quality of cell, within the active cell set and the active cell set has a total of x active cells.

In one example embodiment, obtaining an inter-frequency/inter-RAT signal quality at block 208 may include measuring a signal quality of each cell in the inter-frequency/inter-RAT cell set and applying a selection algorithm to obtain the inter-frequency/inter-RAT signal quality. An inter-frequency cell may have a same RAT as the current active cell but a different frequency. For example, a LTE EUTRAN cell may operate on 2110 to 2170 MHz for downlink transmissions and 1920 to 1980 MHz for uplink transmissions, while a different LTE EUTRAN cell may operate on the frequency range of 2130 to 2190 MHz for downlink transmissions and the frequency range of 1850 to 1910 MHz for uplink transmissions. An inter-RAT cell may operate on a different frequency of a different RAT. For example, one LTE cell may operate on the frequency range of 2110 to 2170 MHz for downlink transmissions and a WCDMA cell may operate on the frequency range of 1920 to 1980 MHz for downlink transmissions. In the example embodiment of the wireless system 100 of FIG. 1, the UE 102 measures signal quality of each cell of the inter-frequency/inter-RAT cell set 120, i.e., the cells 122 and cell 124 and applies a selection algorithm. One simple selection algorithm involves selecting the cell with a strongest signal quality or averaging the signal qualities of the other frequencies of a same or different RAT.

In one example embodiment, blocking an inter-frequency/inter-RAT measurement report at block 210 may include comparing the combined or average signal quality with the selected inter-frequency/inter-RAT signal quality and blocking an inter-frequency/inter-RAT measurement report if the combined or average signal quality is equal to or better than the inter-frequency/inter-RAT signal quality. Blocking the inter-frequency/inter-RAT measurement report may involve different implementations. In one embodiment, blocking the inter-frequency/inter-RAT measurement report involves sending blank data in an inter-frequency/inter-RAT measurement report to the active cell 112. In another embodiment, blocking the inter-frequency/inter-RAT measurement report involves sending dummy data that is recognizable by the active cell 112 in the inter-frequency/inter-RAT measurement report. In yet another example embodiment, blocking the inter-frequency/inter-RAT measurement report does not require sending any inter-frequency/inter-RAT measurement reports at all. Blocking the inter-frequency/inter-RAT measurement report to the active cell comprises causing the active cell to refrain from issuing a command for the UE to switch to a different frequency of a same or different RAT and causing the UE to stay on the current frequency. The method 200 is useful especially if the active cell does not configure appropriate triggering thresholds and measurements.

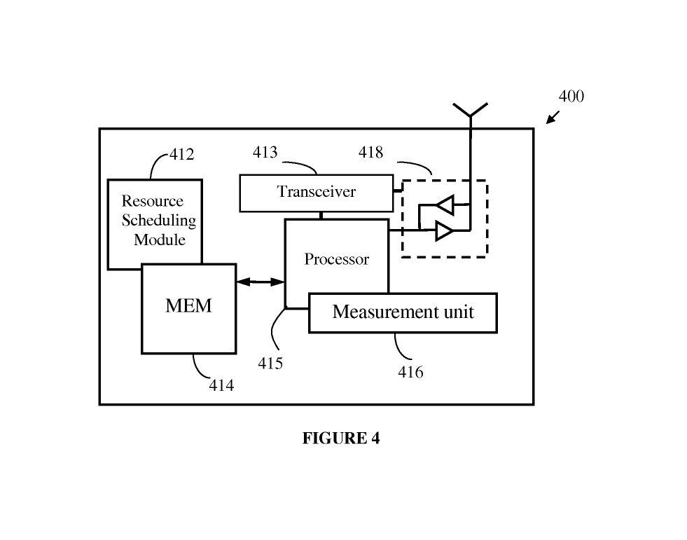

In one example embodiment, the method 200 may be implemented at the UE 102 of FIG. 1 or at the apparatus 400 of FIG. 4. The method 200 is for illustration only and the steps of the method 200 may be combined, divided, or executed in a different order than illustrated, without departing from the scope of the invention of this example embodiment.

FIG. 3a illustrates an example method 300a for filtering out spurious intra-frequency measurements in accordance with an example embodiment of the invention. The UE 102 may measure a signal quality of the active cell at block 302, and this may include measuring the signal quality of the current downlink or uplink channel on the current active cell 112, as prescribed by a controlling protocol such as LTE RRC. The UE 102 may then determine if the measured signal quality falls below a new triggering threshold at block 304 by comparing the measured signal quality with the newly set triggering threshold as described at blocks 202 and 204 of FIG. 2. The UE 102 may enter a compressed mode if the measured signal quality falls below the new triggering threshold at block 306; this is similar to the operations at block 206 of FIG. 2 and is a step that occurs before measuring an inter-frequency/inter-RAT signal quality. Otherwise, at block 308, the UE 102 may stay on the current frequency without making an attempt to make an inter-frequency/inter-RAT measurement, if the measured signal quality is equal to or better than the new triggering threshold. The method 300a has the effect of applying the adjusted triggering threshold and filtering out spurious intra-frequency measurements.

FIG. 3b illustrates an example method 300b for filtering out inter-frequency/inter-RAT spurious measurements in accordance with an example embodiment of the invention. The UE 102 may measure inter-frequency/inter-RAT signal quality at block 312 as prescribed by the controlling protocol such as LTE RRC; preferably the UE 102 is in the compressed mode before the operation of measuring the inter-frequency/inter-RAT signal quality takes place. The UE 102 may determine whether the combined signal quality is less than the measured inter-frequency/inter-RAT signal quality at block 314. The measured inter-frequency/inter-RAT signal quality may be a result of selecting the strongest signal from the inter-frequency/inter-RAT cell set 120 as described in the operation at block 208 of FIG. 2, or may be a result of using an average signal quality of the other frequency of a same or different RAT. The UE 102 may send an inter-frequency/RAT measurement report and cause a switchover to a different frequency of same or different RAT if the combined signal quality is less than the measured inter-frequency/inter-RAT signal quality at block 316. Otherwise, if the combined or average signal quality is equal to or better than the measured inter-frequency/inter-RAT signal quality, the UE 102 may block inter-frequency/Inter-RAT measurement report and remain on the current frequency at block 318. The example method 300b has an effect of filtering out spurious inter-frequency/inter-RAT measurements and avoiding unnecessary switchovers.

FIG. 4 illustrates an example wireless apparatus in accordance with an example embodiment of the invention. In FIG. 4, the wireless apparatus 400 may include a processor 415, a memory 414 coupled to the processor 415, and a suitable transceiver 413 (having a transmitter (TX) and a receiver (RX)) coupled to the processor 415, coupled to an antenna unit 418 and a measurement unit 416. The memory 414 may store programs such as a resource scheduling module 412. The wireless apparatus 400 may be at least part of a generic 4^{th} generation handset.

The processor 415 or some other form of generic central processing unit (CPU) or special-purpose processor such as digital signal processor (DSP), may operate to control the various components of the wireless apparatus 400 in accordance with embedded software or firmware stored in memory 414 or stored in memory contained within the processor 415 itself. In addition to the embedded software or firmware, the processor 415 may execute other applications or application modules stored in the memory 414 or made available via wireless network communications. The application software may comprise a compiled set of machine-readable instructions that configures the processor 415 to provide the desired functionality, or the application software may be high-level software instructions to be processed by an interpreter or compiler to indirectly configure the processor 415.

In an example embodiment, the resource scheduling module 412 may be configured to receive a request with a priority for radio frequency (RF) resource for a traffic load. The resource scheduling module 412 is capable of communicating with an active cell or base station via standards protocol such as RRC protocol.

In one example embodiment, the transceiver 413 is for bidirectional wireless communications with another wireless device. The transceiver 413 may provide frequency shifting, converting received RF signals to baseband and converting baseband transmit signals to RF, for example. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. In some embodiments, the transceiver 413, portions of the antenna unit 418, and an analog baseband processing unit may be combined in one or more processing units and/or application specific integrated circuits (ASICs). Parts of the transceiver may be implemented in a field-programmable gate array (FPGA) or reprogrammable software-defined radio.

As shown in FIG. 4, the wireless apparatus 400 may further include a measurement unit 416, which measures the signal quality level that is received from another wireless device, and compare the measurements with a configured threshold. The measurement unit 416 in collaboration with other modules may implement at least part of the methods 200, 300a and 300b. The measurement unit 416 may be utilized by the wireless apparatus 400 in conjunction with various exemplary embodiments of the invention, as described herein.

In an example embodiment, the antenna unit 418 may be provided to convert between wireless signals and electrical signals, enabling the wireless apparatus 400 to send and receive information from a cellular network or some other available wireless communications network or from a peer wireless device. In an embodiment, the antenna unit 418 may include multiple antennas to support beam forming and/or multiple input multiple output (MIMO) operations. As is known to those skilled in the art, MIMO operations may provide spatial diversity and multiple parallel channels which can be used to overcome difficult channel conditions and/or increase channel throughput. The antenna unit 418 may include antenna tuning and/or impedance matching components, RF power amplifiers, and/or low noise amplifiers.

In general, the various exemplary embodiments of the wireless apparatus 400 may include, but are not limited to, part of a mobile station, an access point or a wireless device such as a portable computer having wireless communication capabilities, Internet appliances permitting wireless Internet access and browsing, as well as portable units or terminals that incorporate combinations of such functions. In one embodiment, the wireless apparatus 400 may be implemented in the network node 102 of FIG. 1.

Without in any way limiting the scope, interpretation, or application of the claims appearing below, a technical effect of one or more of the example embodiments disclosed herein is a removal of spurious measurements reports which may trigger inter-system or inter-frequency handover when the quality of a current intra-frequency link is good enough to maintain a voice or data call. Another technical effect of one or more of the example embodiments disclosed herein is to trigger a measurement event early in a high mobility case so that the UE can have sufficient time to complete an inter-system or inter-rat handover.

Embodiments of the present invention may be implemented in software, hardware, application logic or a combination of software, hardware and application logic. The software, application logic and/or hardware may reside on a mobile station, an access point, a user equipment or similar network device. If desired, part of the software, application logic and/or hardware may reside on access point, and part of the software, application logic and/or hardware may reside on a network element such as a base station. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a mobile device, with one example of a mobile device described and depicted in FIG. 4. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method for a wireless device to control spurious measurement reporting, the method comprising:
obtaining a new signal quality threshold based on a base signal quality threshold and a context-sensitive buffer margin;
setting a current triggering threshold to the obtained new signal quality threshold if the current triggering threshold is smaller than the obtained new signal quality threshold;
if a measured signal quality on a currently active cell falls below the current trigging threshold:
obtaining a combined signal quality of all cells within an active cell set and an inter-frequency signal quality or an inter-radio access technology (RAT) signal quality from an inter-frequency or inter-RAT cell set that is within a receiving range of the wireless device; and
blocking a measurement report to a wireless network element if the obtained combined signal quality is equal to or better than the obtained inter-frequency signal quality or inter-RAT signal quality, the measurement report being one of an inter-frequency measurement report or an inter-RAT measurement report.

2. The method of claim 1, further comprising at least one of:
obtaining the current triggering threshold initially from the wireless network element, wherein the current triggering threshold is set to the base signal quality threshold on a per call basis when a call is initiated;
keeping the current triggering threshold set to the base signal quality threshold if the obtained new signal quality threshold is smaller than or equal to the current triggering threshold; and
entering a compressed mode of operation as directed by the wireless network element if the measured signal quality on the currently active cell falls below the current trigging threshold.

3. The method of claim 1, further comprising obtaining a plurality of context-sensitive margins in an offline manner according to at least one of:
empirical tests and studies of historical measurement and mobility data; and
a plurality of contexts which include a highly-mobile context, a stationary context, and a medially-mobile context, wherein the plurality of contexts and the plurality of context-sensitive margins are stored in a memory of the wireless device via a software download or an initial software installation.

4. The method of claim 3 wherein the context-sensitive buffer margin is dynamically selected from the plurality of context-sensitive margins when a call is initiated and the context-sensitive buffer margin is set in such a way that it allows enough time for the wireless device to complete a handover before the inter-frequency signal quality or inter-radio access technology (RAT) signal quality deteriorates to a point below the base signal quality threshold, wherein the base signal quality threshold is set and sent by the wireless network element in a System Information Block (SIB) 3 message.

5. The method of claim 1 wherein the base signal quality threshold is received from the wireless network element via a broadcast message either on a per call basis or on a semi-permanent basis, the wireless network element being one of an EUTRAN eNodeB, a UTRAN nodeB, and a GSM access node.

6. The method of claim 1 wherein obtaining the new signal quality threshold further comprises adding the context-sensitive buffer margin to the base signal quality threshold, the context-sensitive buffer margin being either a positive or negative number of signal quality measurement.

7. The method of claim 1 wherein obtaining the combined signal quality of all cells within the active cell set comprises measuring the signal qualities of all cells within the active cell set and measuring the inter-frequency or inter-RAT signal quality.

8. The method of claim 7 wherein obtaining the combined signal quality of all cells within the active cell set comprises one of:
determining the combined signal quality based on a calculation of 10*LOG 10 (Cell₁EcNo+ . . . CellₓEcNo); and
determining an average signal quality based on a calculation of (Cell1EcNo+ . . . CellₓEcNo)/x,
where Cell₁EcNo is a signal quality of cell₁, and CellₓEcNo is a signal quality of cell within the active cell set and the active cell set has a total of x active cells.

9. The method of claim 1 wherein obtaining the inter-frequency signal quality or inter-RAT signal quality comprises selecting a strongest signal from a set of inter-frequency or inter-RAT signals detected by the wireless device among the inter-frequency or inter-RAT cell set.

10. The method of claim 1 wherein obtaining the inter-frequency signal quality or inter-RAT signal quality comprises obtaining one of:
an EUTRAN signal quality as defined by a RSRQ or RSRP of a strongest detected EUTRAN cell;
a CDMA2000 signal quality of a 3G network; and
a WiFi signal quality of a wireless local area network.

11. The method of claim 1 wherein blocking the measurement report to the wireless network element comprises at least one of:
sending blank data in the measurement report to the wireless network element;
sending dummy data that is recognizable by the wireless network element in the measurement report to the wireless network element; and
refraining from sending the measurement report to the wireless network element.

12. The method of claim 1 wherein blocking the measurement report to the wireless network element further comprises causing the wireless network element to refrain from issuing a command for the wireless device to switch to a different frequency of a same or a different RAT and causing the wireless device to remain on a frequency currently in use.

13. The method of claim 1 wherein the wireless device is one of a GSM-capable device, a UMTS device, and a LTE device, and blocking the measurement report to the wireless network element further comprises one of:
blocking a UTRAN measurement report if a measured quality of an active UTRAN cell is below the combined signal quality of all cells within an active cell set; and
blocking an EUTRAN measurement report if a RSRQ or RSRP of an EUTRAN cell is below a predetermined level.

14. The method of claim 1, wherein blocking the measurement report to the wireless network element comprise blocking the measurement report when a service quality level deteriorates to a predetermined threshold, the service quality level being defined by a number of call drops.

15. An apparatus for use in a wireless device, the apparatus comprising a processing system configured to:
obtain a new signal quality threshold based on a base signal quality threshold and a context-sensitive buffer margin;
set a current triggering threshold to the new signal quality threshold if the current triggering threshold is smaller than the new signal quality threshold; and
if a measured signal quality on a currently active cell falls below the current trigging threshold:
obtain a combined signal quality of all cells within an active cell set and an inter-frequency signal quality or RAT signal quality from an inter-frequency or inter-RAT cell set that is within a receiving range of the wireless device; and
block a measurement report to a wireless network element if the obtained combined signal quality is equal to or better than the obtained inter-frequency signal quality or inter-RAT signal quality, the measurement report being one of an inter-frequency measurement report or an inter-RAT measurement report.

16. The apparatus of claim 15 wherein the processing system is configured to:
obtain the current triggering threshold initially from the wireless network element wherein the triggering threshold is set to the base signal quality threshold on a per call basis when a call is initiated;
keep the current triggering threshold set to the base signal quality threshold if the new signal quality threshold is smaller than or equal to the current triggering threshold; and
enter a compressed mode of operation as directed by the wireless network entity if the measured signal quality on the currently active cell falls below the current trigging threshold.

17. The apparatus of claim 15 wherein the processing system is configured to obtain a plurality of context-sensitive margins in an offline manner based on at least one of:
empirical tests and studies of historical measurement and mobility data; and
a plurality of contexts which include a highly-mobile context, a stationary context, and a medially-mobile context, wherein the plurality of contexts and the plurality of context-sensitive margins are stored in a memory of the wireless device via a software download or an initial software installation.

18. The apparatus of claim 17 wherein the processing system is configured to select the context-sensitive buffer margin dynamically from the plurality of context-sensitive margins when a call is initiated and to set the context-sensitive buffer margin in such a way that it allows enough time for the wireless device to complete a handover before the inter-frequency signal quality or inter-RAT signal quality deteriorates to a point below the base signal quality threshold wherein the base signal quality threshold is set and sent by the wireless network element in a System Information Block (SIB) 3 message.

19. The apparatus of any of claims 15 wherein the processing system is configured to receive the base signal quality threshold from the wireless network element via a broadcast message either on a per call basis or on a semi-permanent basis, the wireless network element being one of an EUTRAN eNodeB, and a UTRAN nodeB.

20. The apparatus of any of claims 15 wherein the processing system is configured to obtain the new signal quality threshold by adding the context-sensitive buffer margin to the base signal quality threshold, the context-sensitive buffer margin being either a positive or negative number of signal quality measurement.

21.-28. (canceled)
